(19) United States
(12) Patent Application Publication
(10) Pub. No.: US 2004/0139235 A1
(43) Pub. Date: Jul. 15, 2004

(54) Local intelligence, cache-ing and synchronization process

(76) Inventors: Gus Rashid, Middletown, NJ (US); Navruze Rashid, Highlands, NJ (US); Boris Gitlin, Brooklyn, NY (US)

Correspondence Address: Richard C. Woodbridge, Esq., Synnestvedt Lechner & Woodbridge, LLP, P.O. Box 592, Princeton, NJ, 08542-0592, US

(21) Appl. No.: 10/699,461

(22) Filed: Oct. 31, 2003

Related U.S. Application Data
(60) Provisional application No. 60/423,646, filed on Nov. 1, 2002.

(51) Int. Cl. G06F 15/16

(52) U.S. Cl. 709/248; 707/203

(57) ABSTRACT

The present invention is directed to a system and method for synchronizing data between a mobile device and a remote computer or server connected to a centralized database. The invention includes three types of synchronization processes occurring: full, transaction and background synchronization; and permits these synchronization processes to occur even in situations where connection with the remote computer is temporarily lost.

### FIELD OF THE INVENTION

The present invention relates generally to the process of synchronizing two or more collections of data (“datasets”). This process involves identifying differences between this data, and applying changes to one or more of the datasets to make the datasets identical or equivalent.

### BACKGROUND OF THE INVENTION

This invention relates generally to the process of synchronizing two or more separate datasets. Typically one of these datasets is located on a centralized or distributed database that is linked by a central server computer to a dataset associated with a remote client device. Typically this remote client device is utilized by a user over LAN, WAN or wireless networks, examples of which devices include but are not limited to: laptop computers, desktop computers, handheld computers and information devices utilizing PalmOS, Symbian OS, Microsoft Windows CE and phones running Microsoft Windows CE or PalmOS.

Users of such remote client devices typically desire to operate various applications on data locally, then synchronize the data with the central database system when convenient. Often this is either when the device comes back into a wireless coverage area, or when the user docks his device with a cradle, which is connected via a direct local connection (e.g., a serial cable or infrared link) or via a local area net (LAN) connection, to a personal computer (PC). The computer, in turn, has access via LAN or internet to the server residing at a site which is linked to the central database.

An early approach to synchronization between datasets was simply to import or copy one dataset on top of another. This approach, which overwrites a target dataset without worrying about reconciling differences, is adequate only for the simplest of applications.

More sophisticated synchronization techniques have been since developed. For instance, a synchronization technique was developed, in which two datasets are synchronized by a PC-based synchronization system that is specific to a particular handheld device (e.g., ActiveSync or HotSync). The synchronization is conducted in a single session via a direct, local connection and this connection is maintained throughout the synchronization.

Such a prior art, PC-based synchronization scheme functions as follows. It requests and receives one record at a time from the other device's dataset via the local connection to obtain changes that have been made to that dataset since a previous synchronization. Then, the system obtains changes that have been made to the PC's dataset since the previous synchronization. The system next resolves any identified conflicts involving these changes generally through user intervention. Finally, the system replicates the conflict-resolved changes from each of the datasets into the other dataset. The end result is that the two datasets are in identical or equivalent states at the end of the process. During the synchronization, both datasets are “locked” to prevent the user from modifying the datasets.

As more and more types of devices are introduced that include various data to be synchronized between themselves and the server, a need has arisen for improved synchronization schemes to take into account the particular characteristics of each of these new devices and datasets. For instance, it would be desirable to efficiently synchronize user information in such devices using such distant communication mediums which may display high latency or interruptible connection characteristics (e.g., as when the user travels outside an area where wireless coverage is available). It would be further desirable to efficiently synchronize the user information in such devices using message-based communication techniques, especially automated techniques that require little to no user intervention besides initiating synchronization. Unfortunately, the above described PC-based synchronization technique, which is designed for use over a direct local serial connection, is not well-adapted to the characteristics commonly associated with distant and/or message-based communication, especially if errors occur during communication.

As a consequence of these problems in the prior art, user data stored in handheld devices, cellular phones or pagers typically cannot be synchronized with data at a centralized database via wireless messaging in an efficient, error-free, and cost-effective manner. Instead, users typically must wait until they return home or to the office to synchronize their cellular phone or pager with a PC via a serial cable or short infrared link.

Clearly, there is a need for improved synchronization systems and techniques that are suitable for synchronization via wireless or wired message-based communication networks (such as GPRS, GSM, CDPD, 1×RTT and the Internet) that have similar characteristics. The present invention fulfills this and other needs.

### SUMMARY OF THE INVENTION

The invention provides a means and process for the following functionality:

(i) The generation of applications capable of offline processing on client devices through a mobile application development system or environment (referred to herein as the “MDE”),

(ii) Cache-ing and storage of information locally on the client device for offline retrieval and synchronization with remote databases, and

(iii) Synchronization of information entered or modified offline (e.g., locally) with a remote server which is linked to a master database.

In the following discussion of the invention, the term “LIC&S” is used to reference a system of software which enables Local Intelligence, Cache-ing and Synchronization on a mobile client device and between the client and the server. This software comprises two subsystems:

1. A set of run-time components which are binary, pre-compiled executable files installed on both the client and server in order to provide the code necessary to follow the sync process described within the invention herein (LIC&S run-time components or run-time components), and

2. An application or applications (custom application) which are generated through a separate Mobile Development Environment (MDE) or other generation process, which is aware of the LIC&S run-time components, and utilize these run-time components for local storage and cache-ing of data and data operations which are meant to be synchronized with a server. These applications are specific to requirements as outlined by the user or user's organization and may perform any combination of tasks which the software developer might envision. They commonly, however, use the LIC&S run-time components and sync process. Components of a custom application need to be installed on both client and server machines in order for the invention to be enabled.

The above components are depicted in an embodiment of the invention illustrated in FIG. 1. A mobile-aware application has been created, by means of generation within the MDE or independently by software developers and resides in both the client device 105 and the LIC&S server 101 (items 108 and 102, respectively). The LIC&S server 101 which is capable of recognizing and processing the control and data sequences sent to it by the application, and responding to the application with appropriate response control and data sequences, is installed on the illustrated computer.

The LIC&S server 101 is linked to a local application database either on the same computer or, as illustrated in FIG. 1, on another computer across the network 110. Parameters are configured to provide access through the network 110 to the LIC&S server 101 by handheld client devices 105 which are either always or intermittently connected to a wireless network, or sporadically connected to a LAN or WLAN or Internet network.

The custom application and LIC&S run-time components are installed on the client device 105 (items 106 and 107, respectively). Network parameters are configured to allow access to the remote LIC&S server 101 either through the network to which the device hosting the application is connected, or through a network which the desktop host computer (which the device is capable of synchronizing through ActiveSync or HostSync or similar built-in synchronization methods) is connected. To simplify FIG. 1, this latter situation is not illustrated.

For non-background synchronization operations, the user utilizes the application 106 on the client device 105 as an offline application—i.e., it does not retrieve or update remote data, during normal usage, directly through the network. In these situations, the synchronization operations are initiated by the user by executing a synchronization application (“App Manager”) which is provided as part of the LIC&S run-time components 107 installed on the client and which can operate with application 106 to provide it the means for synchronization with the remote database through the LIC&S server 101.

In additional embodiments of the invention, the use of the App Manager to invoke various synchronization operations is not limited to the above, non-background situation. In particular, the following types of synchronizations are available:

1. Full Sync—A full sync refers to a sync process whereby all contents pertaining to the local application are retrieved from the central application database 104 by means of an LIC&S server 101 executing pre-configured SQL SELECT statements and through the network or local direct connection, inserted within the local application database 108.

2. Transaction Sync—Utilizing the Transaction Queue 109, each transaction is synchronized between the client device 105 and the remote database 104 in chronological order. If a single transaction fails, then the process halts and alerts the user of a failure. The user may then perform independent action to verify the correctness of the transaction entered, modify the transaction, etc.

3. Background Sync—Each transaction is synchronized between the client device 105 and the remote database 104 in chronological order, just as is the Transaction Sync. However, the sync is performed in the background without active intervention by the user unless there is an error condition that requires manual intervention. Should the client device 105 loose connection with the server, the sync process suspends until the device regains connection—at which time, the sync process resumes transparently, without intervention by the user.

The types of data operations which may be performed within the LIC&S application are: retrieval of locally cached data records, insertion of new data records, modification of locally cached data records, and deletion of locally cached data records. These transactions are queued locally for synchronization with the remote database, either manually using the App Manager in Transaction Sync mode, or automatically via Background Sync.

### BRIEF DESCRIPTION OF THE DRAWINGS

Various embodiments of the present invention will now be described in detail in conjunction with the annexed drawings, in which:

FIG. 1 depicts the topology of hardware and software deployment as pertains to the preferred embodiment for the present invention;

FIG. 2 describes, by means of a flowchart diagram, the high level process pertaining to generation of an LIC&S custom mobile application as well as installation, configuration and operation of same, as pertains to the present invention;

FIG. 3 describes, by means of a flowchart diagram, the process of operating an LIC&S application within the client device by the user;

FIG. 4 describes, by means of an interaction statechart diagram, the process by means of which the client and server perform the sync process;

FIG. 5 provides a detailed flowchart of the “full sync” process within the client;

FIG. 6A provides a detailed flowchart of the “transaction sync” process within the client; and,

FIG. 6B provides a detailed flowchart of the processing of a response from the server within the “transaction sync” process, when the transaction is of type “insertion”, within the client.

### DETAILED DESCRIPTION

The present invention is directed to a method for synchronizing data between a mobile device and a remote computer or server connected to a centralized database.

### I. Infrastructure and Configuration

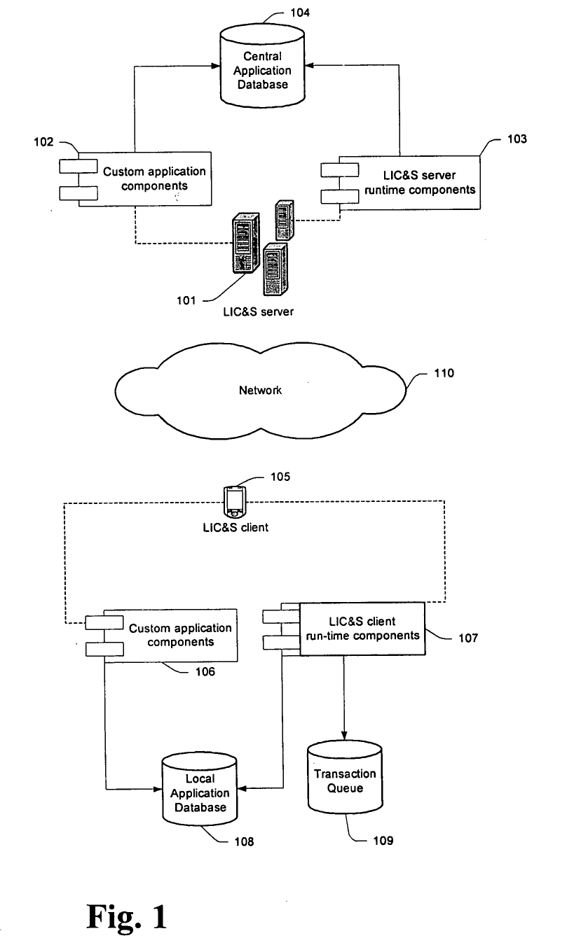

FIG. 1 is a diagram illustrating a suitable architecture for implementation according to an embodiment of the present invention employing a network configuration. As described herein, a network refers to any transmission control protocol/Internet protocol (TCP-IP) based data transport mechanism over which software may exchange data. Examples of networks as pertain to this invention include but are not limited to Local Area Networks (LAN), Wide Area Networks (WAN) (e.g. the Internet), Wireless Local Area Network (WLAN) (e.g. 802.11a and 802.11b networks), and wireless networks such as CDPD, GSM and GPRS.

As depicted in FIG. 1, an LIC&S server 101 is made available on the network, on which the custom application components 102 and LIC&S run-time components 103 are installed. The server 101 along with the custom application and LIC&S run-time components are able to access the central application database 104, which contains schema and other entities specific to the custom application. For purposes of this invention, a database refers to a source of data which may be accessed by software via network or locally to store, retrieve and index data. Examples of such databases include but are not limited to relational database management system (RDBMS) products such as Oracle, Sybase and Microsoft SQL Server. The definition may also include other data sources such as text files, Excel spreadsheets and data feeds from other software objects or vendors locally or across a network.

A client device 105 is configured with custom application components 106 and LIC&S run-time components 107 which have access to a local application database 108 containing schema and other entities specific to the custom application. The custom application components 106 installed on the device correspond to the same custom application for which custom application components 102 are installed on the server 101 (and the code for which have been generated by means of an MDE elsewhere).

As discussed herein, a client device (or client, mobile client or client computer) refers to computer hardware which is generally in possession of a user or mobile worker. Typically such a client device possesses (1) the ability for local data storage and retrieval through custom software as implemented within this embodiment, and (2) the ability for to communicate with a server either through a network or a local connection (such as a serial cable or infrared communication port). Examples of such clients include but are not limited to: workstations, laptop computers, PDAs such as Palm handheld computers, Windows CE/PocketPC based handheld computers or Symbian or other OS-based handheld computers, smart pager devices such as RIM Blackberry devices or smart phones employing Palm OS or PocketPC for Smart Phones OS. Further, as described herein, a server (or server machine or server computer) refers to computer hardware which is able to access a database through a network, and is also available to be accessed by client computers over a network. It should be noted that for security purposes, such a network for client access may be, and in most cases is distinct from the network for database access.

As further depicted in FIG. 1, a transaction queue 109 is installed locally on the client device. As used herein, a transaction queue refers to local storage on a client device or client machine, which stores a list of transactions based on operations performed by the user using the custom application on the device in off-line mode, to be reconciled with the server during the sync process, in FIFO order. This database is accessed by the LIC&S client run-time components 107 in order to store transaction information. The stored transactions are later sent to the LIC&S server 101 during a sync process as described elsewhere within this invention.

The client device 105 is able to communicate with the server 101 by means of a network 110, either (a) directly by means of a network or wireless network card or dial-up modem, or (b) through a proxy connection through a host workstation to which it is connected by means of a direct serial or infrared or other connection as is well known in the prior art.

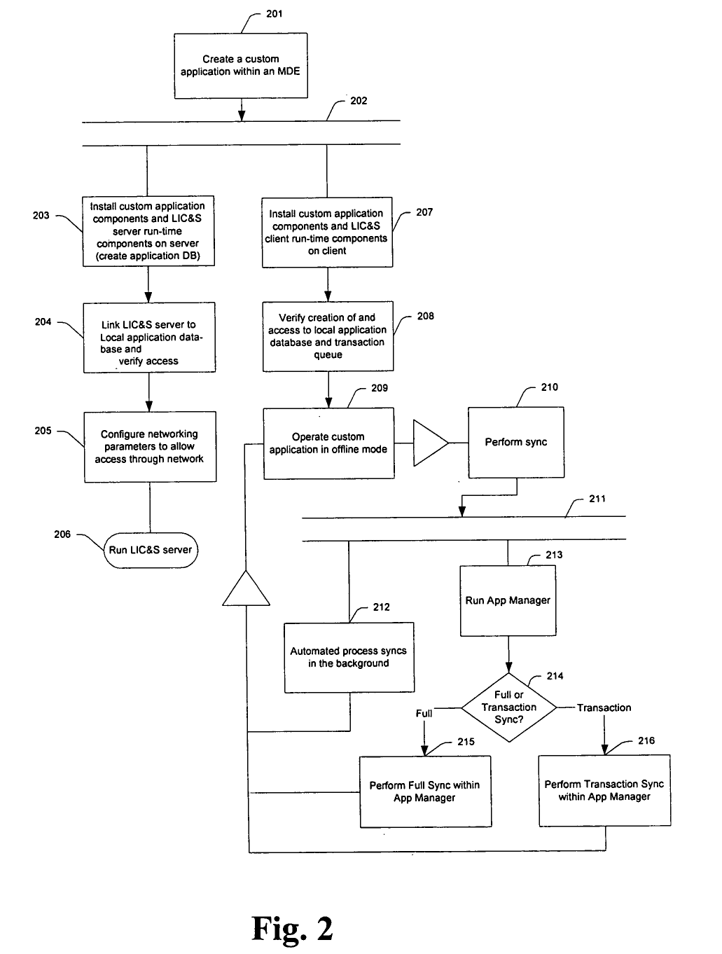

FIG. 2 is a high level flowchart depicting installation, configuration and operation of LIC&S application programs according to an embodiment of the present invention. In particular, FIG. 2 shows the means by which the client device 105 and LIC&S server 101 are both installed with a custom application (106 and 102, respectively) and LIC&S run-time components (107 and 103, respectively). At step 201 a custom application is generated within an MDE with parameters specific to the hardware and software configuration present within the client and server, so it may execute properly on both.

Item 202 in the figure denotes that the two columns of steps below that point (i.e., steps 203-206, and steps 207-214) may be followed in parallel. Step 203 takes place on the server where the LIC&S server run-time components and custom application components are installed (application database schema would be created if needed). Then the server is linked 203 to the application database and access verified 204 with regards to connectivity and requisite access permissions. Next, the server is configured 205 to allow access through the network by the client machines and/or client devices. Finally, the LIC&S server application may be run 206.

On the client, the LIC&S client run-time components and custom application components (including user interface components) are installed 207. Then, the existence of, and connectivity to, the local application database and transaction queue is verified 208. Following this, the custom application may be run in off-line mode 209. In this mode of execution, no connectivity is required, and all insertions, changes and deletions of data within the custom application remain local to the client.

When it is desired to synchronize data with the server, flow control passes to the sync process 210. A background sync and a manual sync can be executed in parallel 211. As used herein a manual sync process refers to a sync process which is invoked overtly by the user of a client device or client machine. It provides feedback during the sync process to the user as to the status of the process. A background sync process is a sync process which executes concurrently with all other processes on the client device. It does not provide a great deal of overt feedback to the user unless an error or event occurs which requires user intervention. This sync process also detects connection conditions and does not execute while the client does not have an active connection to the server. When the client is detected to be back within network coverage, the background sync process resumes synchronization with the server.

As depicted in FIG. 2, if a background sync 212 is desired, it will execute in the background to the custom application running in off-line mode 209, and no further user intervention is required. Flow control passes back to the custom application running in offline mode 209, while the background sync process continues its processing.

If a manual sync is desired, the App Manager process is executed 213. The determination is made whether a transaction or full sync is desired 214. Corresponding to this choice, either the full sync 215 or transaction sync 216 process is executed. Following either manual sync process, control reverts back to the custom application in off-line mode 209. The user then proceeds using the application as he would normally.

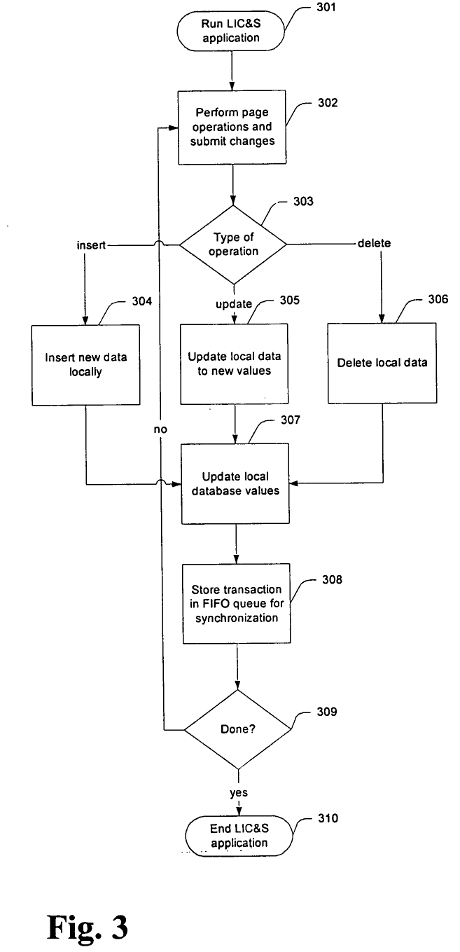

FIG. 3 provides a flowchart diagram illustrating the process by which a user of the client device 105 operates the LIC&S custom application components 106, according to an embodiment of the present invention. At step 301 the user runs the custom application 106. At step 302 actual page operations are performed in accordance with the application's design and changes to data are submitted. The process then determines at step 303 the type of operation (i.e., an “insert”, “update” or “delete”), and performs appropriate actions reflected within the local application database at steps 304-307. Next, at step 308 the transaction queue 109 gets updated with the details of this transaction. Finally, when all such operations have been completed 309, the user ends the application at step 310.

### II. The Sync Process

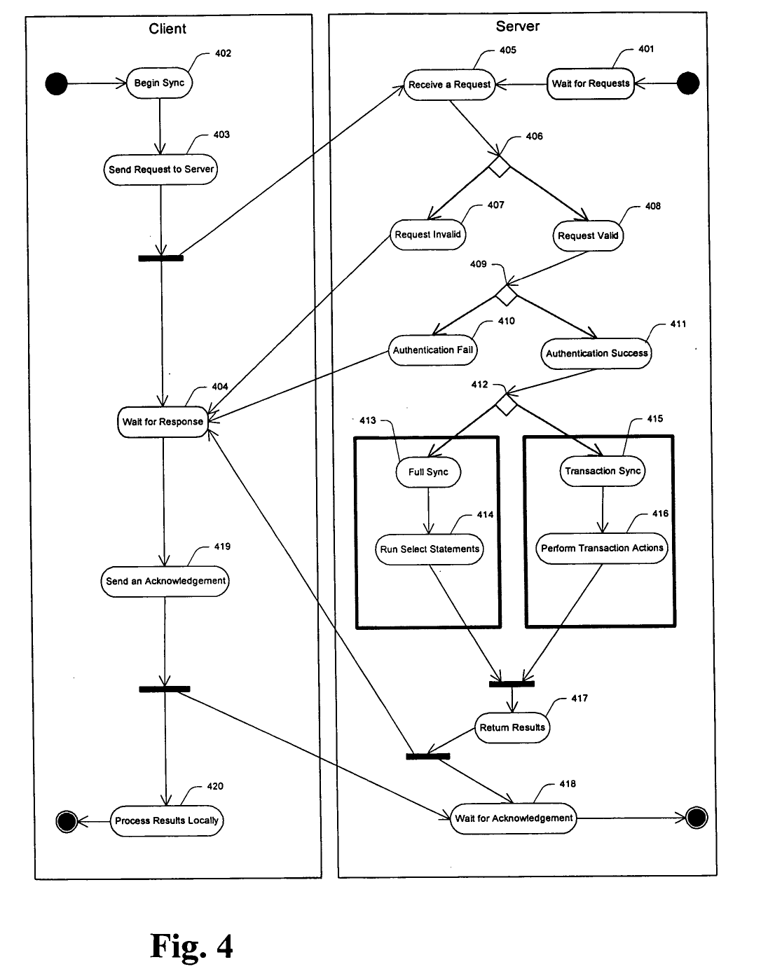

FIG. 4 illustrates an interaction statechart diagram to illustrate the interactions and resulting states of both the client and the server during the sync process, for both full and transaction sync processes, according to an embodiment of the present invention.

The server 101 begins in a state of readiness 401 for a request from a client device 105. At step 402 a client device 105 which initiates a sync process (a “client process”) sends a request 403 to the server 101. This initiation can be done either as part of a background sync process or in response to user actions. The client 105 then goes into a state 404 whereby it awaits a corresponding response for the request from the server 101.

As further illustrated in FIG. 4, the process being executed by the server 101 (“server process”) receives a request 405 and proceeds to perform the following evaluations: firstly, it determines whether the request is a valid one 406 as defined by the semantic conventions listed as part of the format for the request. If the request is invalid 407, the server process then sends a response to the client. If the request is valid 408 it then proceeds to the next evaluation step 409.

At step 409, the server process tests whether the encrypted authentication token embedded within the client request is valid. If the authentication evaluation fails 410, the server process sends a corresponding response to the client 105 which informs the client process that the authentication for the current user has failed. If it the evaluation succeeds 411, the server process then executes a sync process corresponding to the type of sync process requested 412. The type of sync process requested may be either a “Full Sync” or a “Transaction Sync”.

At step 413, execution of the Full Sync process commences, and the server processes the SELECT statements 414 contained within the sync request. It then 417 returns the results, whether successful or unsuccessful, with appropriate data to the client. The server process then enters a state 418 where it awaits an acknowledgement from the client.

The Transaction Sync is performed by means of steps 415 and 416. The actions, which the server process is to perform, are contained within the client request. Additionally, the server process invokes generated custom application components 102 to actually perform the actions denoted within the client request. It then 417 returns the results of the actions, whether successful or unsuccessful, with appropriate data to the client. The server process then enters a state 418 where it awaits an acknowledgement from the client. When an acknowledgement is received, the server process then exits the sync process.

When the client process 404 receives a response from the server, it then 419 sends an acknowledgement to the server which informs the server that the server's response has been received (but not necessarily processed). The client process then 420 processes the contents of the server's response locally, performs appropriate actions and exits the sync process.

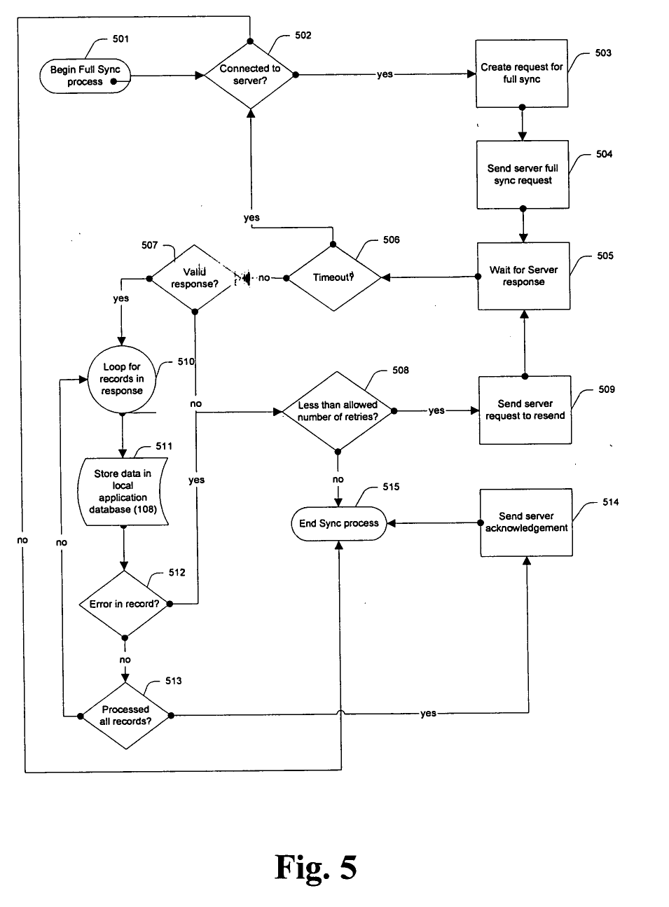

FIG. 5 shows a flowchart diagram of the “full sync” process as performed on the client, according to an embodiment of the present invention. The full sync process is begun at step 501. The client process then 502 checks whether it is connected to the server through the network. If it is not connected, it 515 exits the sync process. Otherwise, it 503 proceeds to create a request for the full sync process, 504 send the request to the server and 505 await a response from the server.

Step 505 exits when either a server response has been received, or the time specified as the maximum amount of time to wait for a serve response (“timeout”) has occurred. As depicted in FIG. 5, at step 506, the client process checks whether a timeout has occurred after it has exited from step 505. If a timeout has occurred, it then jumps to step 502 to check the connection to the server and proceed processing from there. Otherwise, it proceeds to step 507 to check whether the response is a valid one.

If the response is not a valid one, then the process proceeds to step 508 where it checks whether the number of times the process of sending a request and receiving a response from the server (steps 503-505) exceeds the allowable number of retries. If so, it then exits the process at step 515. Otherwise, it creates a request which instructs the server to resend the last response, increments the retry counter, and 509 sends the server the request. Execution then proceeds back to 505 awaiting a server response.

If the response check in step 507 reveals that the server response is indeed valid, then processing continues through to step 510, where the process then loops through each record of data returned as part of the response. For each row, the process stores the data returned in the local application database 511 and tests for an error in the row 512. If there is an error in the row, the process stops iterating and jumps directly to step 508 where it commences to ask the server to resend the previous response as long as the number of retries have not been exceeded. As illustrated in FIG. 5, should this number of retries be exceeded, the synch process ends 515. Absent such a problem, the process checks whether all rows have been processed 513 and continues iterating through the loop 510 until they have. When this happens, processing proceeds to step 514, where a response is sent to the server with an acknowledgement message, and the process exits 515.

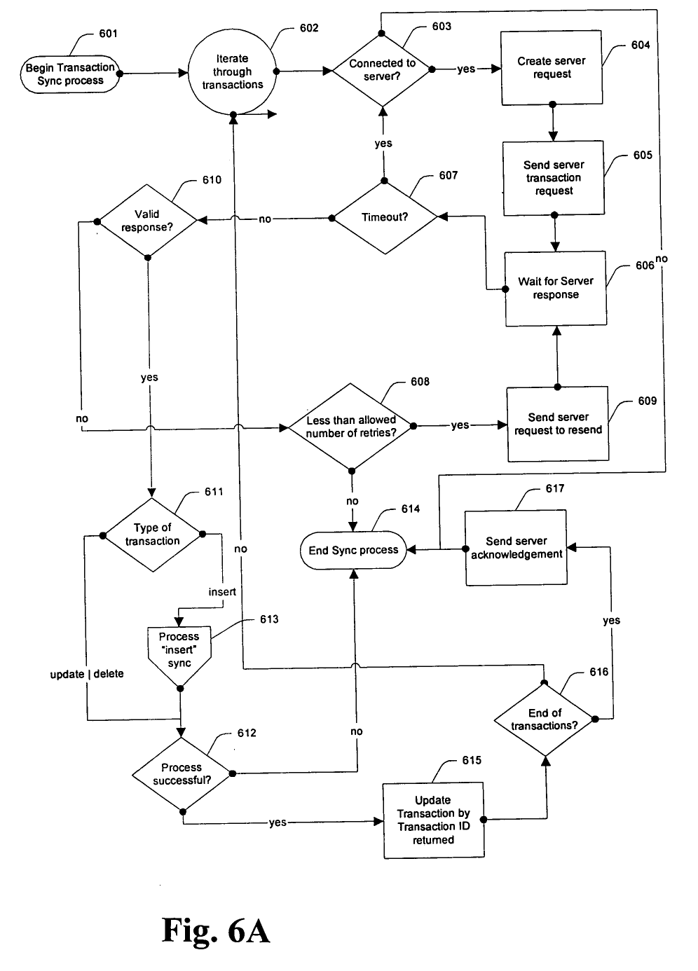

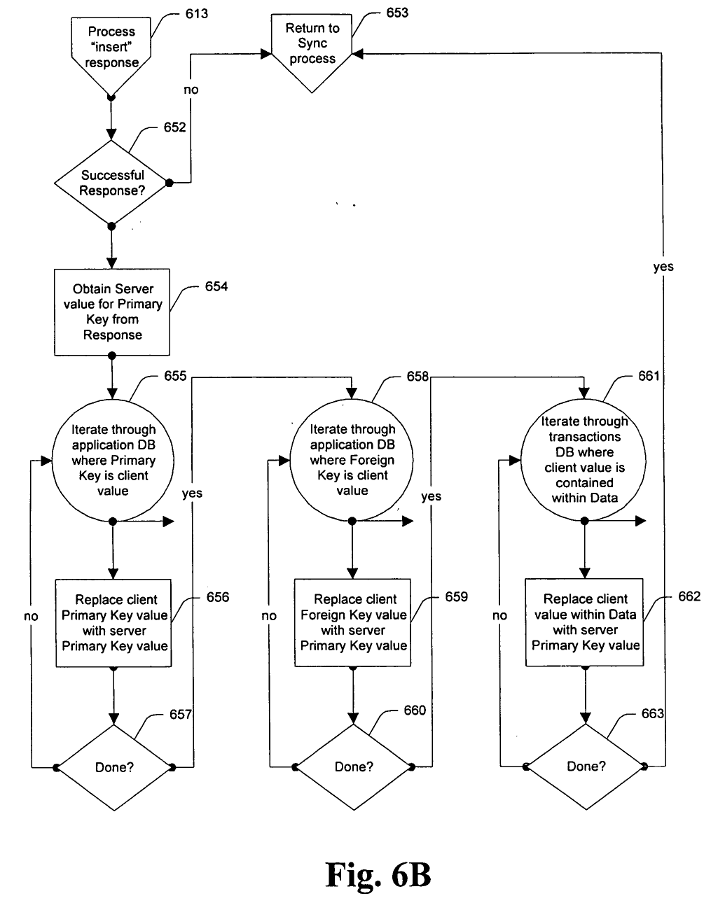

FIG. 6A shows a flowchart diagram of the “transaction sync” process as performed on the client device 105, according to an embodiment of the present invention. The transaction sync process is begun as step 601. For each transaction in the transaction queue 602, the client process iterates steps 603-616. These steps will now be discussed in greater detail.

At step 603 the client process first checks whether it is connected to the server 101 through the network 110. If it is not connected, then it exits the sync process at step 614. Otherwise, at step 604 it proceeds to create a request for the transaction sync process, send the request to the server at step 605 and await a response from the server at step 606.

Step 606 exits when either a server response has been received, or the time specified as the maximum amount of time to wait for a serve response (“timeout”) has occurred. Accordingly, when the client process exits step 606, at check is performed at set 607 to determine whether a timeout has occurred. If a timeout has occurred, control then proceeds to step 603 to check the connection to the server 101 and continue processing from there. Otherwise, it proceeds to step 610 to check whether the response is a valid one.

If the response is not a valid one, then the process proceeds to step 608 where it checks whether the number of times the process of sending a request and receiving a response from the server (steps 604-606) exceeds the allowable number of retries. If so, the client process then exits at step 614. Otherwise, it proceeds to step 609 where it creates a request which instructs the server to resend the last response, increments the retry counter, and sends the server the request. Execution then proceeds back to awaiting a server response at step 606.

If the response check in step 610 reveals that the server response is indeed valid, then processing steps through to step 611, where the process then tests the type of transaction sync response (valid types are “insert”, “update” and “delete”). If the transaction is one of type “update” or one of type “delete” then processing proceeds to step 612 where the response is tested for success. If there has been a failure denoted within the response, then processing stops at 614. Otherwise, the transaction in the transaction queue is updated as having been processed at step 615.

If at step 611 the type of transaction response is “insert”, then additional processing occurs at step which is described within this invention and diagrammed as FIG. 6B. Upon completion of this additional processing, the client process then proceeds to step 612 whose function was already described above (with respect to completed “update” and “delete” transactions).

Following the update of the transaction within the transaction queue at step 615, execution then tests the end of the iteration at step 616 and continues iterating at step 602 until all transactions have been completed or an error condition forces a halt of process. If all transactions have been processed successfully, then an acknowledgement message is generated for the server, and is sent to the server at step 617 before ending the process at step 614.

FIG. 6B shows a flowchart diagram which describes the processing on the client of a specific type of response within a transaction sync process, according to an embodiment of the present invention. The specific type of response received is that pertaining to the insertion of a new record on the client device 105 during the operation of the custom application by the user.

Step 613 in FIG. 6B corresponds with step 613 of the transaction sync process illustrated in FIG. 6A. The next step 652 in the process is to test whether or not the response denotes a successful transaction process on the server. If not, processing proceeds to step 653, whereby it returns to step 612 in FIG. 6A (the point of leaving step 613).

If the response denotes a successful transaction, a “server primary key value” is obtained from the response at step 654. As is well-known in the art, a “primary key” is a record value or a set of record values that uniquely identifies all the records in a particular record set. This server primary key value denotes a new primary key for the local record, say record A(l) as an example, which has been inserted on the server, as say record A(s) as an example. This value will replace the local “client primary key value” for the primary key of the corresponding record A(l).

This client primary key value would have been generated locally by the LIC&S client run-time components 107 when running the local custom application 106, and is intended to be a placeholder or temporary key value until the sync process acquires a new permanent value (i.e., the server primary key value) from the server 101. This is the singular approach by which insertions of new records are reconciled between the client databases 108 and server databases 104.

Until this reconciliation, all local records which refer to this specific record A(l) for which the server primary key value is being obtained, shall have referred to the client primary key value as a means of reference. Accordingly, this shall have been the case for all transactions queued on the transaction queue 109 which refer to the record A(l) and records which refer to A(l) themselves by means of usage of foreign key and other relationships.

The process of replacing all appropriate client primary key values with the newly obtained server primary key value is accomplished through steps 655-663, which will now be described in greater detail. Steps 655-657 iterate through the local application database 108 and replace all records A(l) which possess the client primary key value as a primary key, with the corresponding server primary key value.

Steps 658-660 iterate through the local application database 108 and replace all records A(l) which possess the client primary key value as a foreign key, with the corresponding server primary key value.

Steps 661-663 iterate through the transaction queue and replace all transactions which contain the client primary key value within the Data or PrimaryKeys properties with the corresponding strings having the client server primary key values replaced by the server primary key value. At the end of this iteration, execution returns to the primary sync process 653, and execution proceeds to step 612 in FIG. 6A (the point of leaving step 613).

It is to be understood that the present invention may be implemented in various forms of hardware, software, firmware, special purpose processors or a combination thereof. Preferably, the present invention is implemented in software as a set of application programs and components tangibly embodied on a program storage device. The application may be uploaded to suitable client and server machines comprised with suitable architectures.

The above-described invention can be implemented using standard well-known programming techniques. The novelty of the above-described embodiment lies not in the specific programming techniques but in the use of the steps described to achieve the described results. In a client/server environment, such software programming code may be stored with storage associated with a server. The software programming code may be embodied on any of a variety of known media for use with a data processing system, such as a diskette, or hard drive, or CD_ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

While the invention has been described with reference to the preferred embodiment thereof, it will be appreciated by those of ordinary skill in the art that modifications can be made to the structure and elements of the invention without departing from the spirit and scope of the invention as a whole.

What is claimed is:

1. A method for synchronizing data in a local database with data in a central database, wherein the local database and the central database are each capable of having been changed independently of any synchronization of the local and central databases, said local database contained on a client device, said central database contained on a central computer, the method comprising the steps of:
establishing a communication path between said local database and said central database through a server;
transmitting data over said communication path to a receiving location; and,
synchronizing said transmitted data with a database contained at said receiving location.

2. The method of claim 1 wherein said step of establishing a communication path comprises establishes a communication link over a wireless communication network.

3. The method of claim 1 wherein said step of establishing a communication path comprises establishes a communication link over a wired message-based communication network.

4. The method of claim 1 further comprising a full synchronization operation being performed wherein said local database is said database contained at said receiving location; and wherein said transmitted data comprises data on the central computer pertaining to the local database.

5. The method of claim 4 wherein the client device contains a transaction queue, the method comprising the step of verifying that no entries are present in said transaction queue before said transmitting and said synchronization steps are performed.

6. The method claim 1 wherein the client device contains a transaction queue, the method further comprising a transaction synchronization operation being performed wherein said central database is said database contained at said receiving location; and wherein said transmitted data comprises data present in the transaction queue.

7. The method of claim 6 wherein the method further comprises the steps of:
initiating a background synchronization request by a user; and,
once initiated, requesting active participation by the user only if an error condition requires it.

8. The method of claim 6 further comprising the steps of:
maintaining a temporary client primary key value for entries in said transaction queue; and,
replacing said temporary client primary key value with a server primary key value during said transaction synchronization operation.

9. The method of claim 1 further comprising the step of loading run-time software components onto both said central computer and said client device, said run-time software components capable of performing said synchronization step.

10. The method of claim 9 further comprising the steps of:
generating application programs capable of offline processing functions, and further capable of utilizing said run-time software components; and,
loading said application programs onto both said central computer and said client device.

11. A data storage medium comprising indicia of instruction for a processor to perform a method for synchronizing data in a local database with data in a central database, wherein the local database and the central database are each capable of having been changed independently of any synchronization of the local and central databases, said local database contained on a client device, said central database contained on a central computer, the method comprising the steps of:
establishing a communication path between said local database and said central database through a server;
transmitting data over said communication path to a receiving location; and,
synchronizing said transmitted data with a database contained at said receiving location.

12. The medium of claim 11 wherein said step of establishing a communication path comprises establishes a communication link over a wireless communication network.

13. The medium of claim 11 wherein said step of establishing a communication path comprises establishes a communication link over a wired message-based communication network.

14. The medium of claim 11 further comprising a full synchronization operation being performed wherein said local database is said database contained at said receiving location; and wherein said transmitted data comprises data on the central computer pertaining to the local database.

15. The medium of claim 14 wherein the client device contains a transaction queue, the method comprising the step of verifying that no entries are present in said transaction queue before said transmitting and said synchronization steps are performed.

16. The medium claim 11 wherein the client device contains a transaction queue, the method further comprising a transaction synchronization operation being performed wherein said central database is said database contained at said receiving location; and wherein said transmitted data comprises data present in the transaction queue.

17. The medium of claim 16 wherein the method further comprises the steps of:
initiating a background synchronization request by a user; and,
once initiated, requesting active participation by the user only if an error condition requires it.

18. The medium of claim 16 further comprising the steps of:
maintaining a temporary client primary key value for entries in said transaction queue; and,
replacing said temporary client primary key value with a server primary key value during said transaction synchronization operation.

19. The medium of claim 11 further comprising the step of loading run-time software components onto both said central computer and said client device, said run-time software components capable of performing said synchronization step.

20. The medium of claim 19 further comprising the steps of:
generating application programs capable of offline processing functions, and further capable of utilizing said run-time software components; and,
loading said application programs onto both said central computer and said client device.
